(19) United States
(12) Patent Application Publication
(10) Pub. No.: US 2010/0002478 A1
(43) Pub. Date: Jan. 7, 2010

(54) SYSTEM TO IMPROVE A VOLTAGE MULTIPLIER AND ASSOCIATED METHODS

(76) Inventors: Charlie C. Hwang, Hopewell Junction, NY (US); Paul D. Muench, Poughkeepsie, NY (US); Donald W. Plass, Poughkeepsie, NY (US); Michael Sperling, Poughkeepsie, NY (US)

Correspondence Address: INTERNATIONAL BUSINESS MACHINES CORPORATION;Richard Lau, IPLAW DEPARTMENT / Bldg 008-2, 2455 SOUTH ROAD - MS P386, POUGHKEEPSIE, NY, 12601, US

(21) Appl. No.: 12/166,433

(22) Filed: Jul. 2, 2008

(51) Int. Cl. H02M 3/18

(52) U.S. Cl. 363/60

(57) ABSTRACT

A system to improve a voltage multiplier may include a voltage multiplier circuit, and a capacitor carried by the multiplier circuit. The system may also include a transistor to charge an up voltage of the capacitor.

### RELATED APPLICATIONS

This application contains subject matter related to the following co-pending application entitled “System to Improve a Multistage Charge Pump and Associated Methods” and having an attorney docket number of POU920080082US1, the entire subject matter of which is incorporated herein by reference in its entirety. The aforementioned application is assigned to the same assignee as this application, International Business Machines Corporation of Armonk, N.Y.

### FIELD OF THE INVENTION

The invention relates to the field of voltage multipliers, and, more particularly, to voltage multipliers using charge pumps.

### BACKGROUND OF THE INVENTION

A charge pump is an electrical circuit that can take in a direct current (“DC”) voltage and generate an output voltage that is higher than the original. An alternate configuration is a negative charge pump which generates a voltage that can be below ground.

A prior art embedded dynamic random access (“eDRAM”) memory cell is illustrated in FIG. 1. During a write to this memory cell, a high voltage is put on the ‘Gate’ 15 and the voltage on the ‘Node’ 11 gets stored by the capacitor 13. The higher the voltage, the faster the capacitor will be charged. A charge pump can be used to generate this high voltage.

During a read of the memory cell, a high voltage is put on the ‘Gate’ 15 and the voltage that is stored on the capacitor 13 can be read at the ‘Node’ 11. The higher the voltage, the faster the read of the memory cell.

During standby, the gate voltage will be driven low to turn off the N-Type transistor 17. Leakage thru this transistor 17 will drain the capacitor. A charge pump can be used to generate this negative voltage to minimize the leakage.

With reference to FIGS. 2-4, in a typical positive charge pump, the positive charge pump will create a new voltage that is higher than the power supply (called VPP). A comparison is usually done to figure out whether the output voltage is high enough. The compare is usually made between some reference voltage and a divided down output voltage.

If the output voltage is too low, the pump can be activated. Looking at FIG. 2, we see P-type 19a-19c and N-type 21 transistors which act as digital switches in FIGS. 3 & 4. A shorted connection refers to the transistor switch being closed while an open connection refers to the transistor switch being open. There are two phases of operation of the charge pump, which are charging and pumping. During charging as shown in FIG. 3, the power supply voltage VDD appears across the capacitor 23. During pumping, the charge built up across the capacitor 23 can be discharged into the output VPP. Together with the comparison and reference voltage these components may make up a charge pump system.

A charge pump may be used in a voltage multiplier system. Voltage multipliers are used in a variety of circuits including memory subsystems and analog circuits such as phased-locked loops, input/outputs, and the like. The basic circuit for generating increased voltages is a charge pump where a capacitor is charged such that the power supply voltage is across the terminals, and then boosted to generate double the power supply voltage.

For example, FIGS. 5-7 illustrate a typical prior art voltage multiplier and its various states. In such, the capacitor 25 is charged to the power supply (VDD), and then it's pumped to the output.

### SUMMARY OF THE INVENTION

In view of the foregoing background, it is an object of the invention to provide an efficient voltage multiplier.

This and other objects, features, and advantages in accordance with the invention are provided by a system to improve a voltage multiplier that may include a voltage multiplier circuit, and a capacitor carried by the multiplier circuit. The system may also include a transistor to charge an up voltage of the capacitor.

The voltage multiplier circuit's output voltage may be greater than a power supply voltage minus a transistor threshold voltage provided by the capacitor, which may result in overvoltage protection for the voltage multiplier circuit. The transistor may comprise a negative-type transistor.

The system may also include an additional transistor connected to the capacitor to convey the voltage multiplier circuit's output voltage.

The system may further include a single clock producing a clock signal shared by the transistor and additional transistors acting as digital switches. The voltage multiplier circuit's output voltage may be twice the power supply voltage minus the transistor threshold voltage.

Another aspect of the invention is a method to improve a voltage multiplier. The method may include providing a voltage multiplier circuit. The method may also include charging an up voltage of a capacitor within the voltage multiplier circuit with a transistor.

The method may further include protecting the voltage multiplier circuit by limiting the voltage multiplier circuit's output voltage to a multiple of a power supply voltage minus a transistor threshold voltage provided by the capacitor. The method may additionally include conveying the voltage multiplier circuit's output voltage via a transistor switch connected to the capacitor.

The method may further include a clock signal connected to the digital transistor switches.

### BRIEF DESCRIPTION OF THE DRAWINGS

FIG. 1 is a schematic block diagram of a prior art eDRAM charge pump.

FIG. 2 is a schematic block diagram of a prior art positive charge pump.

FIG. 3 is a schematic block diagram of the prior art positive charge pump of FIG. 2 charging.

FIG. 4 is a schematic block diagram of the prior art positive charge pump of FIG. 2 pumping.

FIG. 5 is a block diagram of a prior art voltage multiplier.

FIG. 6 is a schematic block diagram of the prior art voltage multiplier of FIG. 5 charging.

FIG. 7 is a schematic block diagram of the prior art voltage multiplier of FIG. 5 pumping.

FIG. 8 is a block diagram of a voltage multiplier in accordance with the invention.

FIG. 9 is a schematic block diagram of the voltage multiplier of FIG. 8 charging.

FIG. 10 is a schematic block diagram of the voltage multiplier of FIG. 8 pumping.

FIG. 11 is a flowchart illustrating method aspects according to the invention.

FIG. 12 is a flowchart illustrating method aspects according to the method of FIG. 11.

FIG. 13 is a flowchart illustrating method aspects according to the method of FIG. 12.

FIG. 14 is a flowchart illustrating method aspects according to the method of FIG. 13.

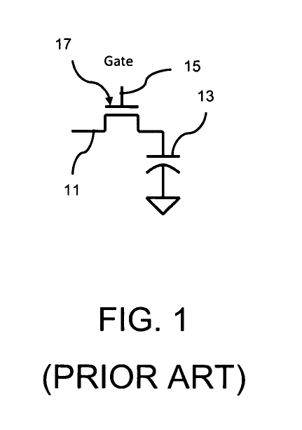

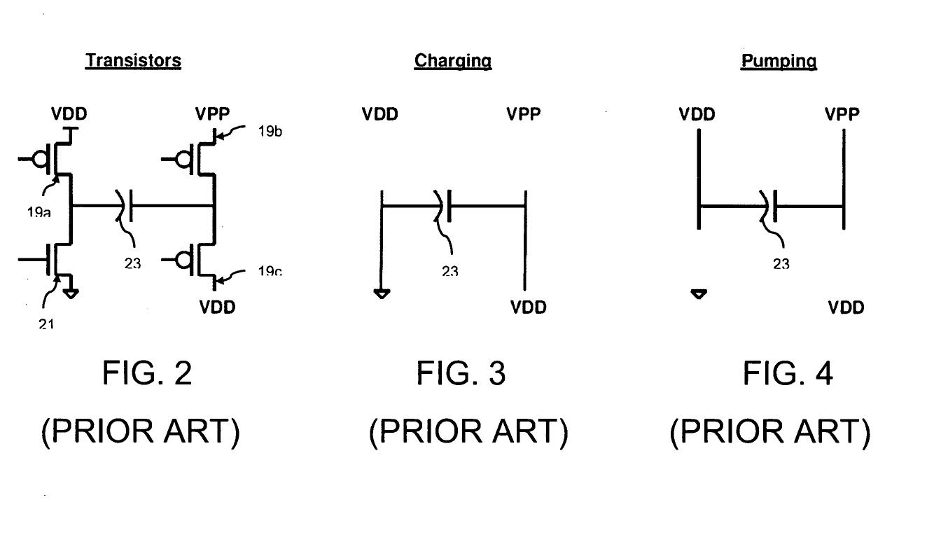

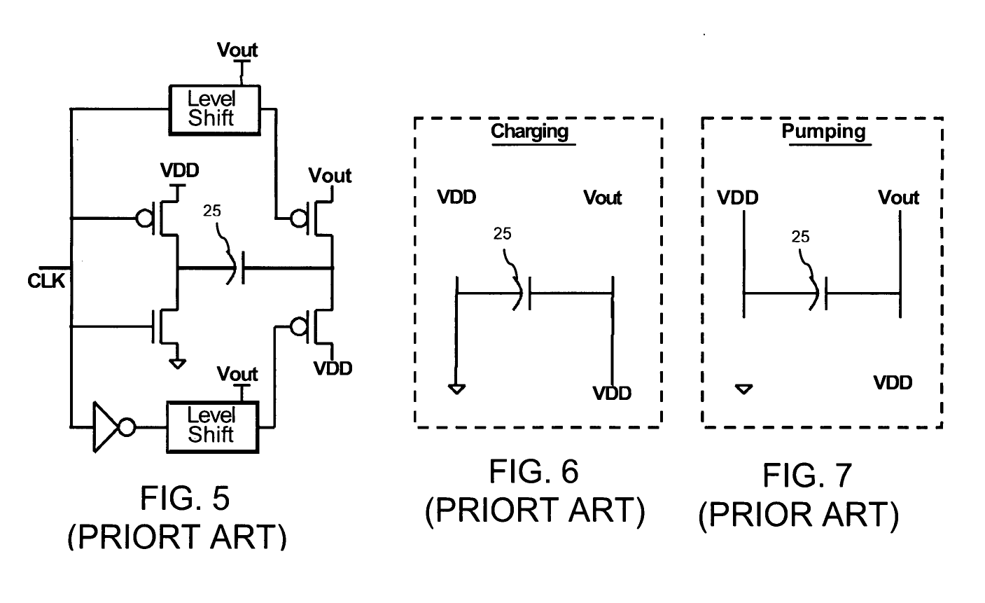

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one skilled in the art, the invention may be embodied as a method, system, or computer program product. Furthermore, the invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the invention may be written in an object oriented programming language such as Java, Smalltalk, C++ or the like. However, the computer program code for carrying out operations of the invention may also be written in conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

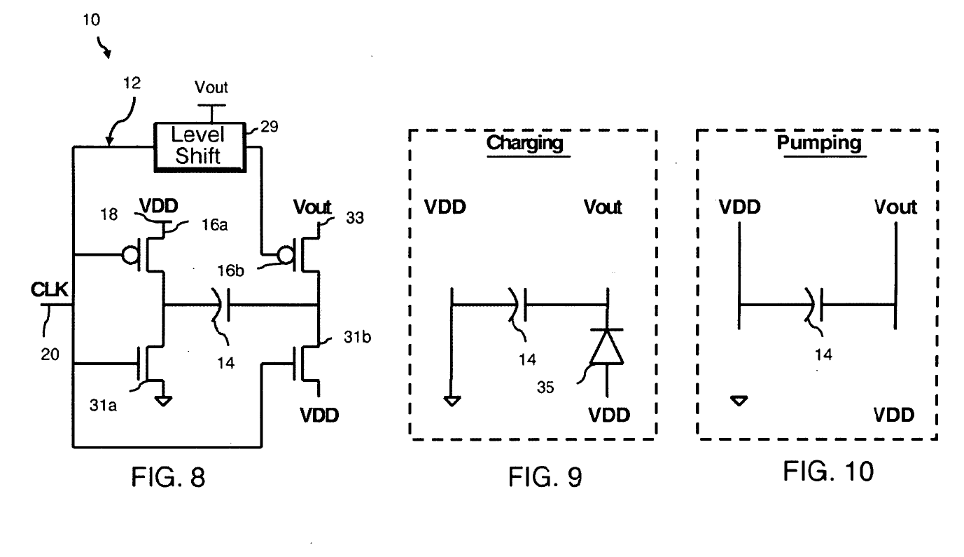

Referring to FIGS. 8-10, a system 10 to improve a voltage multiplier is now described. The system 10 includes a voltage multiplier circuit 12, and a capacitor 14 carried by the multiplier circuit, for example. The system also includes a transistor 31b to charge an up voltage of the capacitor 14, for instance. In one embodiment, the capacitor 14 provides an output voltage and not the forward voltage.

In another embodiment, the voltage multiplier circuit 12's output voltage is greater than a power supply voltage minus a transistor threshold voltage provided by the capacitor 14, which results in overvoltage protection for the voltage multiplier circuit. The transistor 31b comprises a negative-type transistor, for example.

In another embodiment, the system 10 also includes a power supply 18 connected thru transistor 16a to the capacitor. In addition the system contains transistor 16b which is used to convey the voltage multiplier circuit 12's output voltage.

In one embodiment, the system 10 further includes a single clock 20 producing a clock signal shared by the transistors 31a, 31b and 16a. The clock signal is also shared by transistor 16b through a voltage level shifter 29. In other words, no complementary clock signal needs to be generated by system 10. The voltage multiplier circuit 12's output voltage is twice the power supply 18 voltage minus the transistor threshold voltage, for instance.

The system 10 can be thought of in more generalized terms. In one embodiment, the transistors, e.g. transistor 16a and/or 16b, and 31a and/or 31b, act as switches and the clock 20 controls them either to be open or closed. The power supply 18, e.g. VDD, is connected to the source of one of the positive-type transistors, e.g. transistor 16a and/or 16b, and the source of a negative-type transistor 31b. In this case, the power supply 18, e.g. VDD, is the signal that gets passed thru when the switches are closed. Generally, the power supply 18, e.g. VDD, comes from outside the chip and comprises a voltage that can be used by the circuits. As a result, the power supply 18, e.g. VDD, is not directly connected to the capacitor 14, but is connected thru a switch, for example.

FIGS. 9 and 10 represent circuit equivalents during the two phases of the clock 20. In these equivalent representations, the transistors are either switches or diodes, e.g. diode 35, for one of the negative-type transistors 31b. In this embodiment, when the clock 20 is a ‘1’, see FIG. 9, the system 10 is charging the capacitor 14's voltage such that the capacitor voltage is the power supply 18, e.g. VDD, minus the threshold voltage of one of the negative-type transistors 31b. In other words, the negative-type transistor 31b will limit the charge delivered to the capacitor 14. When the clock 20 is a ‘0’, see FIG. 10, the system 10 discharges the capacitor 14 onto the node Vout 33 because both of the positive-type transistors 16a and 16b are controlled to be in their closed position, while the negative-type transistors 31a and 31b are open.

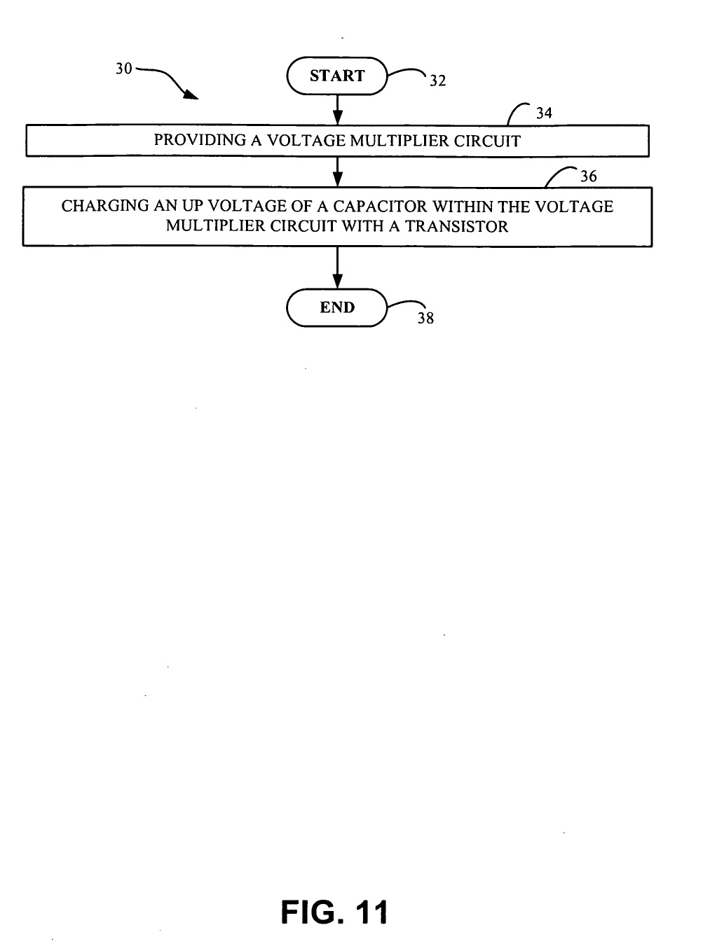

Another aspect of the invention is a method to improve a voltage multiplier, which is now described with reference to flowchart 30 of FIG. 11. The method begins at Block 32 and may include providing a voltage multiplier circuit at Block 34. The method may also include charging an up voltage of a capacitor within the voltage multiplier circuit with a transistor at Block 36. The method ends at Block 38.

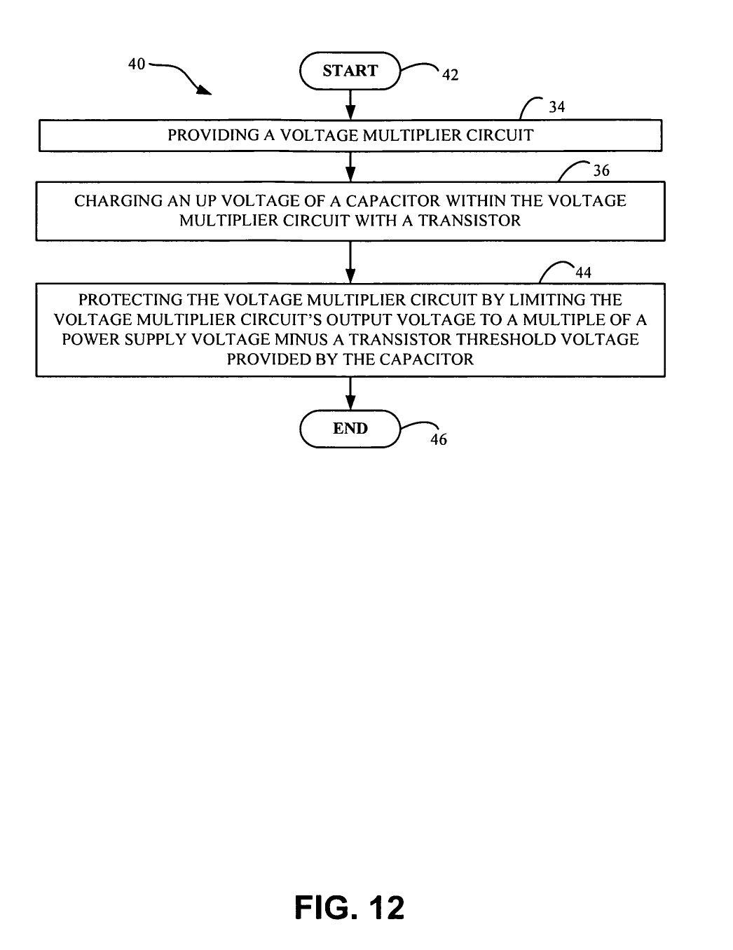

In another method embodiment, which is now described with reference to flowchart 40 of FIG. 12, the method begins at Block 42. The method may include the steps of FIG. 11 at Blocks 34 and 36. The method may also include protecting the voltage multiplier circuit by limiting the voltage multiplier circuit's output voltage to a multiple of a power supply voltage minus a transistor threshold voltage provided by the capacitor at Block 44. The method ends at Block 46.

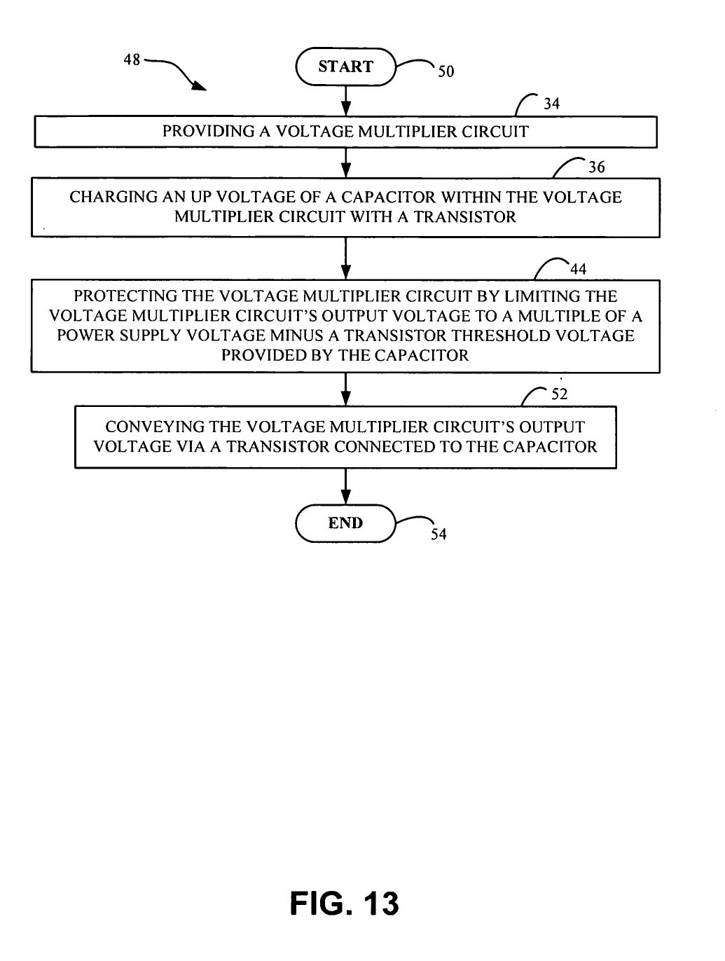

In another method embodiment, which is now described with reference to flowchart 48 of FIG. 13, the method begins at Block 50. The method may include the steps of FIG. 12 at Blocks 34, 36, and 44. The method may also include conveying the voltage multiplier circuit's output voltage via a transistor connected to the capacitor at Block 52. The method ends at Block 54.

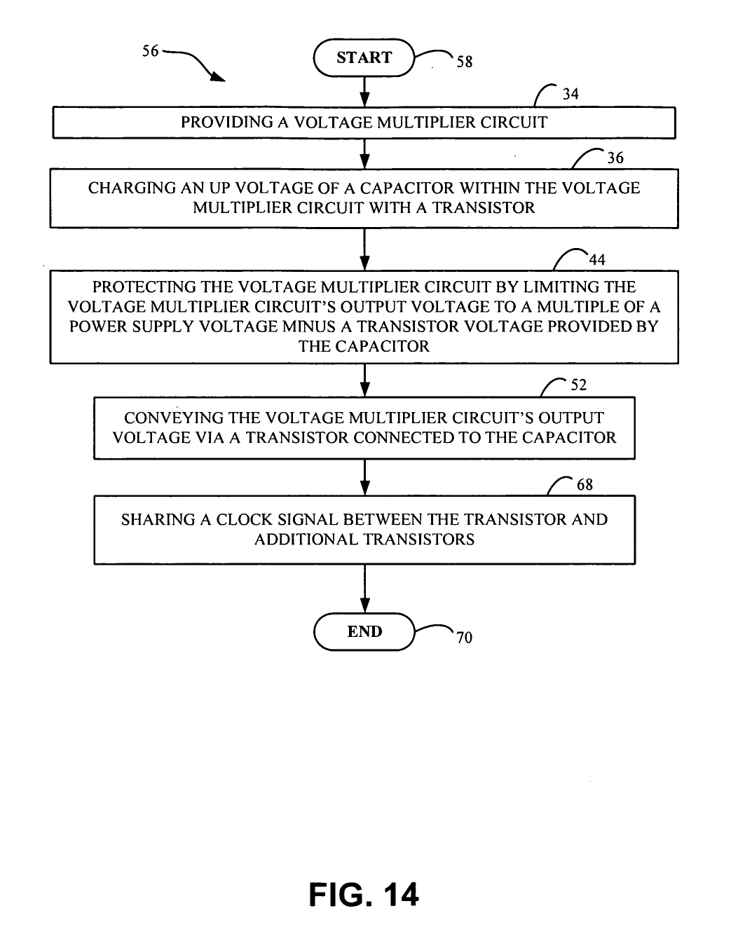

In another method embodiment, which is now described with reference to flowchart 64 of FIG. 14, the method begins at Block 66. The method may include the steps of FIG. 14 at Blocks 34, 36, 44, 52, and 60. The method may also include sharing a clock signal between the transistors at Block 68. The method ends at Block 70.

In view of the foregoing, the system 10 provides overvoltage protection of a voltage multiplier. In addition, the efficiency of system 10 will be much higher than the typical voltage multiplier. This is important because there are reliability metrics that relate to the maximum voltage that can be used in modern semi-conductor processes.

For example, if the power supply is doubled in a typical voltage multiplier, the maximum voltage can be exceeded thereby causing device breakdown. Also, there are certain circuits that only need a slight boost of the power supply and not the full doubling. In such a case, using the typical voltage multiplier will waste area and power due to the need for level-shifting transistors that steal current from the output.

The capabilities of the system 10 can be implemented in software, firmware, hardware or some combination thereof.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention. Furthermore, the use of the terms a, an, etc. do not denote a limitation of quantity, but rather denote the presence of at least one of the referenced item.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

That which is claimed is:

1. A system to improve a voltage multiplier, the system comprising:
a voltage multiplier circuit;
a capacitor carried by said multiplier circuit; and
a transistor to charge an up voltage of said capacitor.

2. The system of claim 1 wherein said voltage multiplier circuit's output voltage is greater than a power supply voltage minus a transistor threshold voltage provided by said capacitor resulting in overvoltage protection for said voltage multiplier circuit.

3. The system of claim 2 wherein said transistor comprises a negative-type.

4. The system of claim 3 further comprising a transistor connected to said capacitor to convey said voltage multiplier circuit's output voltage.

5. The system of claim 5 further comprising a single clock producing a clock signal shared by said transistor and additional transistors.

6. The system of claim 2 wherein said voltage multiplier circuit's output voltage is twice the power supply voltage minus the transistor threshold voltage.

7. A method to improve a voltage multiplier, the method comprising:
providing a voltage multiplier circuit; and
charging an up voltage of a capacitor within the voltage multiplier circuit with a transistor.

8. The method of claim 7 further comprising protecting the voltage multiplier circuit by limiting the voltage multiplier circuit's output voltage to a multiple of a power supply voltage minus a transistor threshold voltage provided by the capacitor.

9. The method of claim 8 wherein the transistor comprises a negative-type.

10. The method of claim 9 further comprising conveying the voltage multiplier circuit's output voltage via a transistor connected to the capacitor.

11. The method of claim 10 further comprising sharing a clock signal between the transistor and additional transistors.

12. A system to improve a voltage multiplier, the system comprising:
a voltage multiplier circuit;
a capacitor carried by said multiplier circuit; and
a negative-type transistor to charge an up voltage of said capacitor;
wherein said voltage multiplier circuit's output voltage is twice a power supply voltage minus a transistor threshold voltage provided by said capacitor resulting in overvoltage protection for said voltage multiplier circuit.

13. The system of claim 12 further comprising a transistor connected to said capacitor to convey said voltage multiplier circuit's output voltage.

14. The system of claim 13 further comprising a single clock producing a clock signal shared by said transistor and additional transistors.
